(19) United States
(12) Patent Application Publication
(10) Pub. No.: US 2007/0198632 A1
(43) Pub. Date: Aug. 23, 2007

(54) Transferring multimedia from a connected capture device

(75) Inventors: Benjamin R. Peart, Redmond, WA (US); Jordan L. K. Schwartz, Seattle, WA (US); Tomasz S.M. Kasperkiewicz, Redmond, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/346,158

(22) Filed: Feb. 3, 2006

(51) Int. Cl. G06F 15/16

(52) U.S. Cl. 709/203

(57) ABSTRACT

A method and system to transmit multimedia data from a connected capture device is provided. The system includes a capture device wirelessly connected to a secure storage device, which authenticates and communicates with a second communication device. The connected capture device captures multimedia data and metadata and stores the multimedia data in an unprocessed format. The multimedia data and metadata are stored separately and are automatically transmitted to the secure storage device. The secure storage device is polled by the second communication device to retrieve the multimedia data and metadata matching criteria selected by a user of the second communication device. The second communication device receives the multimedia data and metadata and encodes the multimedia data and metadata based on a predefined format. Moreover, the second communication device infers additional metadata from the received multimedia data and metadata and encodes the additional metadata in the predefined format.

### CROSS-REFERENCE TO RELATED APPLICATION

Not applicable.

### STATEMENT REGARDING FEDERALLY SPONSORED RESEARCH OR DEVELOPMENT

Not applicable.

### BACKGROUND

Conventionally, multimedia cameras exist largely as unconnected devices. Digital images captured by the multimedia cameras are transferred to personal computers through memory cards or by directly connecting the camera to the personal computer. The direct connection may be facilitated by standard Universal Serial Bus (USB) cables. Also, the direct connection may be facilitated wirelessly through infrared communications, where the camera and the personal computer have an unobstructed line-of-sight to. Conventionally, the user must initiate the transfer of the multimedia from the multimedia camera to the personal computer.

Some multimedia cameras may be connected wirelessly using mobile networks. The wireless connections allow users to transfer files from the multimedia camera to personal computers without having a direct connection or a line-of-sight. For instance, mobile phones with data capability may utilize Multimedia Message System (MMS) messages to compose and send messages with one or more multimedia parts. Mobile phones with built-in or attached cameras may generate MMS messages to compose, address, send, receive, and view MMS messages having digital images captured by the built-in or attached camera. The MMS messages may be sent to other mobile phones. Conventional mobile phones having a persistent connection to mobile networks require manual user intervention when performing steps to transfer captured multimedia and metadata.

### SUMMARY

In an embodiment, a method to transmit multimedia data between a first communication device and a second communication device is provided. Multimedia data is captured and associated with metadata by the first communication device. After authenticating the first communication device at the second communication device, the metadata and multimedia data is packaged in a communication message and transmitted to the second communication device.

In an embodiment the second communication device is a secure storage server, and the first communication device wirelessly connects to the second communication device. The first and second communication device store multimedia data separately from the metadata associated with the multimedia data, and the multimedia data is stored in an unprocessed format.

In another embodiment, a system having a first communication device, a secure storage server and a second communication device transmits multimedia data captured by the first communication device to the second communication device via the secure storage server. The first communication device wirelessly transmits multimedia data captured by the first communication device to the secure storage server. The second communication device automatically queries the secure storage server at specified time intervals to retrieve multimedia data and metadata matching criteria specified in the queries. Moreover, the second communication device may encode the retrieved multimedia data and metadata in a specified format. In an alternate embodiment, the second communication device registers with the secure storage server, and the secure storage server automatically transmits notifications to the second communication device when new multimedia data and metadata are available. Also, the secure storage server may automatically push the new multimedia data and metadata to the second communication device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is network diagram that illustrates an exemplary computing environment, according to embodiments of the invention;

FIG. 2 is a block diagram that illustrates a metadata system utilized by embodiments of the invention;

FIG. 3 is a graphical user interface that illustrates a configuration procedure for a wireless communication device, according to embodiments of the invention;

FIG. 4 is a graphical user interface that illustrates a configuration procedure for a communication device implementing the metadata system, according to embodiments of the invention; and

FIG. 5 is a flow diagram that illustrates a method to transfer multimedia data and metadata from a first communication device to a secure storage server, according to embodiments of the invention; and

FIG. 6 is a flow diagram that illustrates a method to transfer multimedia data and metadata from the secure storage server to a communication device implementing the metadata system, according to embodiments of the invention.

### DETAILED DESCRIPTION

Multimedia data represents digital images, video and audio singularly or any combination of video, audio and digital images. Embodiments of the invention transfer multimedia data and metadata corresponding to the multimedia data from a multimedia capture device to a secure storage server. A communication device continuously polls the secure storage server to determine whether multimedia data and metadata meeting specified criteria are stored on the secure storage server. The communication device retrieves and encodes the multimedia data and metadata meeting the specified criteria. Accordingly, the multimedia data and metadata is transferred from a multimedia capture device to a communication device that encodes the multimedia data and metadata.

A system that transfers multimedia data and metadata captured on a first communication device to a second communication device via a secure storage server may include one or more computers that have processors executing instructions associated with transferring and encoding the multimedia data and metadata. In certain embodiments, a user of the first communication device supplies the metadata, which may include manual annotations, such as keywords, ratings, etc. Moreover, the second communication device may include processors that infer additional metadata from the multimedia data and metadata captured on the first communication device. The processors may implement voice recognition, face recognition and image correction functions to derive the additional metadata. Accordingly, the system provides manual metadata annotations received from a user and automatic metadata annotations based on inferences associated with the multimedia data and metadata.

In alternate embodiments of the invention, the manual or automatic metadata processing may occur on the first communication device, second communication device, secure storage server, or any suitable combination. Additionally, the processors may be communicatively connected to a client computer through a communication network, and the client computers may include portable devices, such as, laptops, personal digital assistants, smart phones, etc.

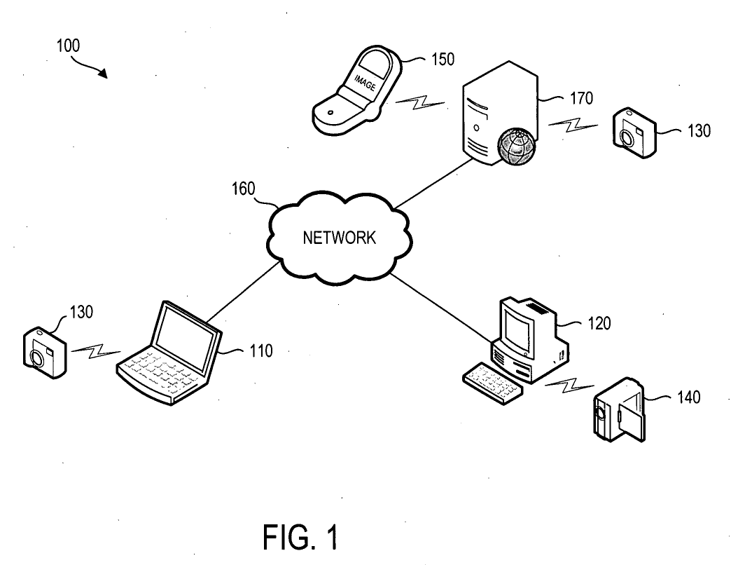

FIG. 1 is network diagram that illustrates an exemplary computing environment 100, according to embodiments of the invention. The computing environment 100 is not intended to suggest any limitation as to scope or functionality. Embodiments of the invention are operable with numerous other special purpose computing environments or configurations. With reference to FIG. 1, the computing environment 100 includes client devices 110 and 120, multimedia capture devices 130, 140 and 150, server 170 and a communication network 160. The client devices 110 and 120, multimedia capture devices 130, 140 and 150, server 170 represent communication devices that may transmit or receive multimedia data and metadata over the communication network 160.

The client devices 110 and 120 each have processing units, coupled to a variety of input devices and computer-readable media via communication buses. The processing units enable face and voice recognition functions that allow additional metadata to be inferred from multimedia data and metadata captured by the multimedia capture devices 130, 140 and 150. Additionally, the processors allow the client devices to apply corrections to the multimedia data and the metadata and to encode the multimedia data and metadata in a standardized format. The processors may utilize the computer-readable media to access instructions associated with transferring the multimedia data and metadata. The computer-readable media may include computer storage and communication media that are removable or non-removable and volatile or non-volatile. By way of example, and not limitation, computer storage media includes electronic storage devices, optical storage devices, magnetic storage devices, or any medium used to store information that can be accessed by client devices 110 and 120 and communication media may include wired and wireless media. The input devices may include, mice, keyboards, joysticks, controllers, microphones, cameras 130, camcorders 140, or any suitable device for providing user input to the client devices I 10, and 120.

The multimedia capture devices include digital cameras 130, digital camcorders 140 and smartphones or cameraphones 150. The multimedia capture devices 130, 140 and 150 capture multimedia data, such as, audio, video and digital images and store the multimedia data along with metadata provided by the multimedia capture device. In an embodiment of the invention, the captured multimedia data is stored in an unprocessed format. The unprocessed format may be a compressed digital image format associated utilized by the multimedia capture devices. Additionally, the unprocessed format provides multimedia data that is minimally processed and obtained from image sensors associated with the multimedia capture devices 130, 140, and 150. In certain embodiment, the metadata associated with the captured multimedia data is stored separately from the unprocessed multimedia. The. metadata may include data provided by the multimedia capture devices 130, 140, and 150. The metadata may include time information based on a clock on the multimedia capture devices 130, 140, and 150. The metadata may also include a description that describes the multimedia data and whether the multimedia is copyright-protected. Moreover, the multimedia capture devices 130, 140 and 150 may provide device information, which include, but is not limited to, model and make, orientation, aperture, shutter speed, focal length, metering mode, and film speed information. In an embodiment of the invention, the multimedia capture devices 130, 140 and 150 provide location information, which could come from Global Positioning System (GPS) receivers connected to the multimedia capture devices 130, 140 and 150.

The client devices 110 and 120 communicate with a server 170 that stores the unprocessed multimedia data and metadata captured by multimedia capture devices 130 and 140. The server 170 is a secure storage server that provides limited access to the multimedia and metadata. The server is external and remote to the client devices 110 and 120. Access to the server 170 may be regulated by tokens and username-password combinations, digital signatures, bioemetrics, public-private key pairs or other network security mechanisms familiar to one of ordinary skill in the art. In certain embodiments authenticating the user or client devices 110 and 120 allows the multimedia data and metadata to be pulled from the server 170 by the client devices 110 and 120 or pushed by the server 170 to the client device 110 and 120. Optionally, after authentication the communications between the client devices 110 and 120 and server 170 are secured through Secure Socket Layers (SSL) or any other equivalent security mechanism to prevent unauthorized access. In an embodiment, the tokens provide the multimedia capture devices 130, 140 and 150 upload rights to the server 170. After the multimedia capture devices 130, 140 and 150 are authenticated by the server 170 based on the tokens, the multimedia capture devices may upload multimedia data and metadata to the server 170. When the client devices 110 and 120 attempt to download the multimedia data and metadata from the server 170, the client devices 110 and 120 are prompted to enter the username-password combination. After providing the correct username-password combination, the client device 110 and 120 are allowed to access the multimedia data and metadata. In an alternate embodiment, the server 170 may be a component of the client devices 110 or 120.

In certain embodiments of the invention, the client devices 110 and 120 may store application programs that provide computer-readable instructions to implement various heuristics. Polling queries may be automatically formulated at specified intervals by an application stored on the client devices 110 and 120. In an embodiment, the intervals may be hourly, weekly or daily. The client devices 110 and 120 may issue the queries to the server 170 to retrieve multimedia data and metadata matching specified criteria. Alternatively, the client devices 110 and 120 may register with the server 170, and the server 170 may automatically send a message to the client devices 110 and 120 indicating that there is new multimedia data and metadata to download or push the new multimedia data and metadata to the client devices 110 and 120 without user intervention. In certain embodiments, the server pushes the new multimedia data and metadata to the client devices 110 and 120 after the client devices 110 and 120 acknowledges the new multimedia data and metadata via a dialog box. In an embodiment, during registration, the client devices 110 and 120 may provide the server 170 with a profile describing multimedia data and metadata that the client wants to receive. Accordingly, when the serverl70 receives multimedia and metadata that matches the profile, the multimedia and metadata is pushed to the client devices 110 and 120.

The communication network 170 may be a local area network, a wide area network, satellite network, wireless network or the Internet. The client devices 110 and 120 may include laptops, personal digital assistants, or desktop computers. The client devices 110 and 120 utilize the communication network 120 to communicate with the server 170. The server 170 receives communications from the client devices 110 and 120 and processes the communications to generate a result set. The computing environment 100 illustrated in FIG. 1 is exemplary and other configurations are within the scope of the invention.

A computer-implemented method is a method implemented at least in part by a machine or a method implemented at least in part by a computing device. The machine or computing device includes, but are not limited to, a laptop, desktop, personal digital assistant, or multi-processing systems, or any device capable of storing or executing instructions associated with the methods described in the following description.

Embodiments of the invention automatically transfer multimedia data and metadata from multimedia capture devices to a user's workflow on a computing device. The automated transfer may include an upload and download to supply the computing device with the multimedia data and metadata. The automated transfer also applies keyword metadata to facilitate later retrieval of the multimedia data. In certain embodiments, after the multimedia capture device captures the multimedia data, the multimedia data is silently (or optionally with a notification, but without required user initiative or intervention) uploaded to a web site associated with a secure storage server. From the web site, a user may choose to edit, share or print the multimedia data. Alternatively, the web site may automatically perform edit, share or print actions based on the metadata associated with the multimedia data. In certain embodiments, the automated transfer is also initiated when the computing device polls the web site to determine whether new multimedia data has been uploaded to the web site. When the computing device is informed that new multimedia data is stored at the web site, the computing device downloads the multimedia data, infers additional metadata, and encodes the multimedia data and metadata is a specified format. In an alternate embodiment, the web site registers the computing device and pushes the new multimedia data and metadata to the computing device without user intervention.

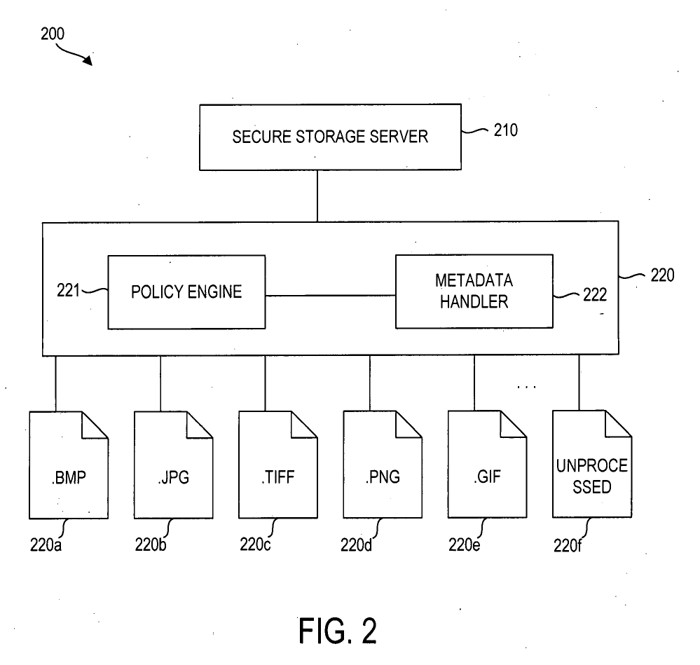

FIG. 2 is a block diagram that illustrates a metadata system 200 utilized by embodiments of the invention. The metadata system includes a secure storage server 210 communicatively connected to a client device 220. The secure storage server 210 stores multimedia data and metadata captured by a multimedia capture device. Additionally, the secure storage server 210 limits access to the multimedia data and metadata based on authorizations stored on the secure storage server 210.

The client 220 authenticates at the secure storage server 210 and begins to poll the secure storage server 210 to retrieve metadata and multimedia data matching criteria included in queries issued by the client 220. The client 220 stores and further processes the metadata and multimedia data retrieved from the secure storage server 210. In an embodiment, the client 220 polls the secure storage server 210 to determine whether new multimedia data has been uploaded. When new multimedia data is detected, the client 220 automatically (optionally with a notification, but without required user initiative or intervention) downloads the multimedia. The client 220 may view and archive the multimedia. In an alternate embodiment, the secure storage server 210 registers the client 220. After the secure storage server 210 receives new multimedia data and metadata, the secure storage server 210 authenticates the client 220 and pushes the new multimedia data and metadata to the client 220.

In certain embodiments, the client 220 further processes the metadata and multimedia data by encoding the metadata and multimedia data in a standardized format. The client 220 may also further process the multimedia data and metadata by inferring additional metadata based on the metadata or multimedia data retrieved from the secure storage server 210. The client 220 includes a policy engine 221 and a metadata handler 222 to further process the retrieved multimedia data and metadata. The client 220 may retrieve and encode files having varying formats. Additionally, the client 220 may utilize the metadata associated with multimedia data to perform a collection actions on the multimedia data, such as displaying the new multimedia data in a slideshow, sending the new multimedia data as a electronic message, printing out the new multimedia data, etc. These actions may be specified in the metadata supplied by a user of the multimedia capture device. Additionally, some actions may require user to authorization before the action is performed.

When the multimedia data is a digital image, the formats may include, but is not limited to, .bmp, .jpg, .tiff, .png, .gif and unprocessed. When the multimedia data is a video, the formats may include, but are not limited to, .asf, .mov and .mpg. When the multimedia data is an audio, the formats may include, but are not limited to, .wav, wma and .mp3. Each format may support one or more metadata schemas that define the type of metadata that is associated with multimedia. The schemas include, but are not limited to, International Press Telecommunication Council (IPTC), Exchangeable Image File Format (EXIF) and Extensible Metadata Platform (XMP). The metadata handler 222 reads the multimedia data and metadata retrieved from the secure storage server 210 and communicates with the policy engine 221 to update the metadata associated with the multimedia data. The metadata handler 222 extracts the metadata and sends the extracted metadata to the policy engine 221 to determine whether the schemas associated with the format of the multimedia data requires additional metadata.

In certain embodiments, the policy engine 221 may process multimedia data and metadata having a format that stores the multimedia data and metadata separately to transform the format to a different format where the multimedia data and metadata are embedded in the same file. The policy engine 221 may indicate that voice and face recognition should be applied to the multimedia data to infer additional metadata, such as, name, age, sex, ethnicity, etc from the multimedia. The additional metadata is encoded in the metadata based on the format associated with the multimedia data. The policy engine 221 may also define corrections to apply to the multimedia data or metadata based on the multimedia capture device. The corrections may include, but are not limited to, color, noise and. metadata corrections.

In an alternate embodiment, the secure storage server 210 may initiate server-side processing based on the metadata associated with multimedia data uploaded from the multimedia capture device. The metadata may initiate automatic actions, such as, printing or sending e-mail. For instance, multimedia data may include intents-based tags, such as, “print this image” or “send to grandparent”, which may cause the secure storage server to perform an action. Also, the secure storage server 210 may provide multimedia corrections, such as color, exposure, or red eye corrections. In an embodiment, corrections may be distributed between the secure storage server 210 and the client 220. The secure storage server 210, client 220 or any other suitable device may be configured as a location where significant processing of multimedia data and metadata occur. For instance, when the client 220 is a personal computer with large amounts of processing power, the intense multimedia data and metadata processing is completed by the client 220. On the other hand, when the client 220 is a mobile phone having limited processing power, the intense multimedia data and metadata processing is completed by the secure storage 220 or any other suitable device having substantial amounts of processing power when compared to the client 210. In alternative embodiments, corrections that are processing-intensive, require large quantities of memory and processing cycles are handled at the client 220, while corrections that are not processing-intensive are handled by the secure storage server 210. In an embodiment, the secure storage server may automatically infer metadata that includes, but is not limited to, location or venue information and calendar or holiday information. Accordingly, the secure storage server 210 may accept multimedia data from an authenticated source, such a multimedia capture device, perform a set of lightweight actions based on the metadata associated with the multimedia data, and send the pre-processed multimedia data to an authenticated target, such as client 220 for additional heavyweight processing.

The multimedia capture device may include a device that is able to wirelessly communicate with a secure storage server. The wireless communication may involve mobile networks or 802.11 networks. In certain embodiment of the invention, the multimedia capture device may be a portable mobile phone that communicates to the secure storage server via the mobile networks. The mobile phone may include an application that listens for multimedia capture events. When new multimedia data is captured, the multimedia data is automatically uploaded to a web site of the user's choice, such as the secure storage server. The application may add metadata, such as, security attributes that restrict access to specified individuals, keywords, location information specifying where the multimedia was taken, authorship indicating who captured the multimedia, and voice command including intents or annotations that indicate actions to be taken or describe the multimedia data. In certain embodiments, the location metadata may include orientation information, such as a direction the multimedia capture device is pointing, distance to a subject captured by the multimedia capture device, etc. In an embodiment, the orientation information may be described as a vector normal to a plane of an image sensor of the multimedia capture device utilizing a three-dimensional coordinate system. For example, the orientation information may include direction and elevation information for the multimedia capture device. Thus, the orientation information enables identification of the subject captured by the multimedia capture device.

Prior to sending the multimedia data and metadata, the application is authenticated via a token assigned by the secure storage server. The application stores the token and presents the token to the secure storage server when attempting to upload the multimedia data and metadata. After the application is authenticated, the multimedia data and metadata are uploaded to the secure storage server. In certain embodiments, the multimedia data and metadata are sent in an unprocessed format because of the limited processing capabilities of the multimedia capture device. The metadata and multimedia data may be stored separately and communicated to the secure storage server via Hypertext Transfer Protocol (HTTP) messages or any other suitable communication protocol.

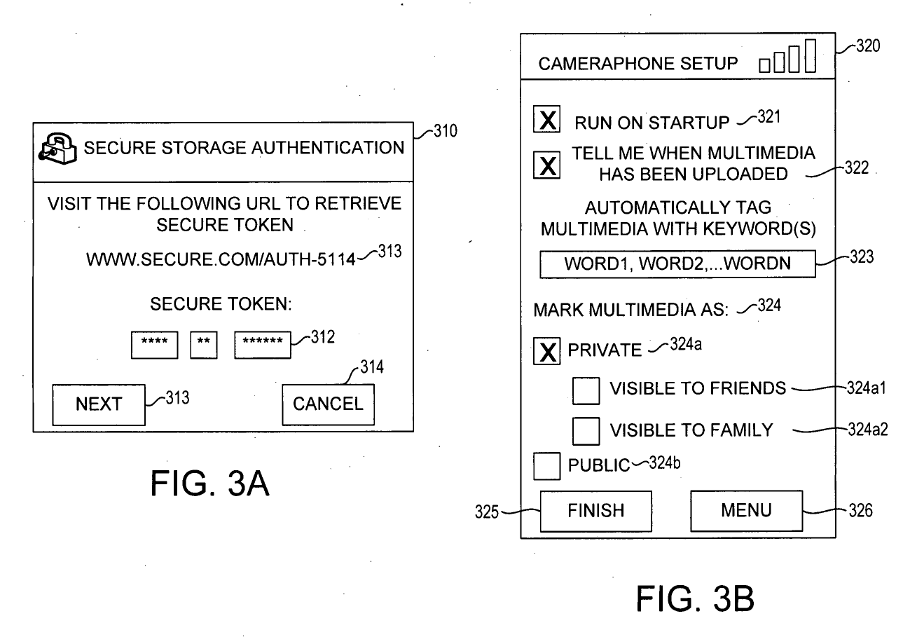

FIG. 3 is a graphical user interface that illustrates a configuration procedure for a wireless communication device, according to embodiments of the invention.

The wireless communication device, such as a cameraphone, is associated with an authentication token. With reference to FIG. 3A, an authentication dialog 310 associated with the wireless communication device asks for a token 312. The token 312 is provided by a secure storage server 313. The user of the wireless communication device accesses the secure storage server 313 and retrieves the token 312. When the user enters the token 312, and proceeds to the next configuration phase a cameraphone setup dialog 320 is presented.

With reference to FIG. 3B, a set of options 321-322 and 324 are presented to configure the application. The user may utilize option 321 to indicate that the application should be initialized when the wireless communication device is powered on. Option 322 may provide the user with a notification when multimedia data and metadata has been uploaded to the secure storage server. The user may specify keywords in an input field 323. The keyword entered in the input field are associated with multimedia data captured by the wireless communication device. Option 324 may provide an indication that limits access to the multimedia data. The multimedia data captured by the device may be marked private 324a or public 324b. When the multimedia data is marked public 324b, after the multimedia data and metadata is uploaded to the secure storage server anyone may access the secure storage server to manipulate the multimedia. When the multimedia is marked private 324a, only the user that captured the multimedia data may view or manipulate the multimedia. Moreover, multimedia data marked private 324a may define a set of individuals that may view or manipulate the multimedia data, the set of individuals may include friends 324a1 or family 324a2. Accordingly, access to the uploaded multimedia data and metadata may be restricted based on the configuration associated with the wireless communication device.

After the multimedia data and metadata is stored on the secure storage server an authenticated client may access the multimedia data and metadata. The client may authenticate via a username password combination. After authentication, the client may initiate a background application that polls the secure storage server for new multimedia data matching criteria, such as, multimedia data tagged as coming from a cameraphone. When multimedia data matching the criteria is found, the client automatically downloads the multimedia data and optionally provides a notification indicating that multimedia data has been retrieved from the secure storage server. The client may utilize a local log having timestamp and multimedia identifiers to track multimedia data that is downloaded from the secure storage server.

In an embodiment, the client may merge metadata and multimedia data according to standards specified by the client. For instance, the client may encode metadata according to XMP or EXIF schemas associated with the multimedia data. In certain embodiments, when the metadata associated with the multimedia data include a voice stream, the voice stream is stored in a separate and alternate file stream, which is associated with the multimedia data and non-voice metadata. Alternatively, a speech recognition function may be utilized to extract text metadata from the voice metadata, and the text metadata is stored as caption or keyword metadata, which may be embedded in the multimedia data. Additionally, the client may apply corrections to multimedia data when the multimedia data is captured by multimedia capture devices that have predictable flaws. In an embodiment, the client may apply transformations to the multimedia data to increase multimedia quality when the multimedia data suffers from predictable flaws associated with the multimedia capture devices.

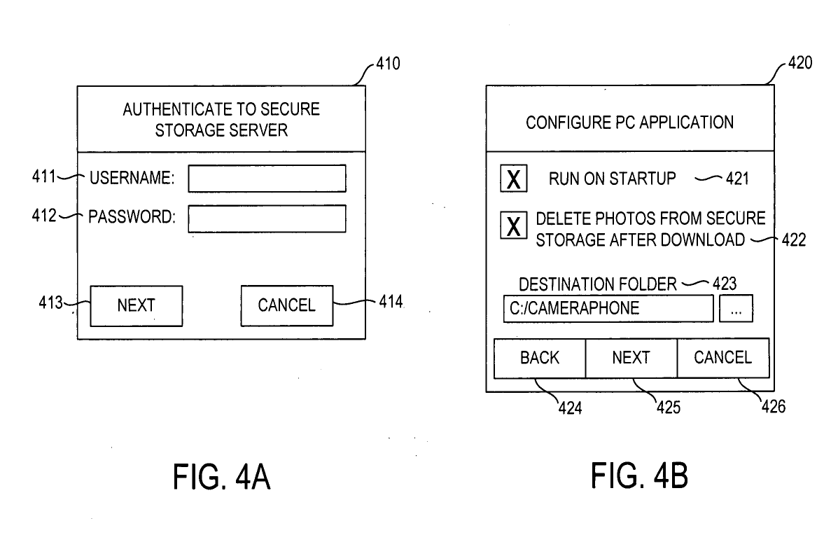

FIG. 4 is a graphical user interface that illustrates a configuration, procedure for a communication device implementing a metadata system, according to embodiments of the invention. With reference to FIG. 4A, the communication device is a client that authenticates to the secure storage server based on a username and password combination 410. With reference to FIG. 4B a set of options 421-422 are presented to a user. After the client is authenticated, the client application may be configured to always run when the client is powered on 421. Additionally the client application may be configured to delete the multimedia data from the secure storage device after the client downloads the multimedia data 422. In an alternative embodiment, the secure storage device may be configured to archive the multimedia data and metadata, and the multimedia capture device may be configured to automatically delete multimedia data and metadata stored on the multimedia capture device after the multimedia data and metadata is archived on the secure storage device. The client application may also specify a storage location 423 for the multimedia data downloaded from the secure storage server. Once the client is completely configured, the client initiates a polling process, where the client automatically queries the secure storage server to find multimedia data meeting specified criteria. The multimedia data that match the specified criteria is downloaded, stored in the specified location and further processed by the client to encode the metadata and multimedia data according to a specified format.

The metadata and multimedia data captured by the multimedia capture device may be uploaded to secure storage automatically. No user intervention is required for the upload to occur after the multimedia capture device is properly configured. The multimedia capture device may generate a notification that informs the user that the multimedia data and metadata was uploaded to the secure storage server.

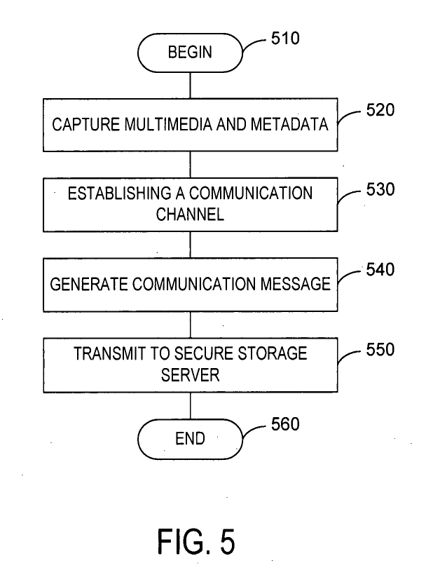

FIG. 5 is a flow diagram that illustrates a method to transfer multimedia data and metadata from a first communication device to a secure storage server, according to embodiments of the invention.

The method begins in step 510 when the multimedia capture device is power on. In step 520, multimedia data and metadata is captured by the multimedia capture device. In step 530, the communication channel between the multimedia capture device and secure storage server is established. In an embodiment, the multimedia capture device is authenticated based on a token previously received from the secure storage server. A communication message including the multimedia data and metadata is generated by the multimedia capture device, in step 540. The communication messages are transmitted to the secure storage server in step 550. Optionally, in step 550, a notification may be generated to inform the user that multimedia data and metadata was uploaded to the secure storage server. The method ends in step 560. In certain embodiments, the communication message is a. HTTP message or any other suitable communication protocol.

The multimedia data and metadata stored on the secure storage server is automatically transferred to a client for further processing based on criteria included in polling requests. The multimedia data and metadata that match the criteria is downloaded and encoded in a standard format. The further processing may include multimedia corrections and client actions, such as printing and sending e-mails based on metadata describing intent-tags associated with the downloaded multimedia data.

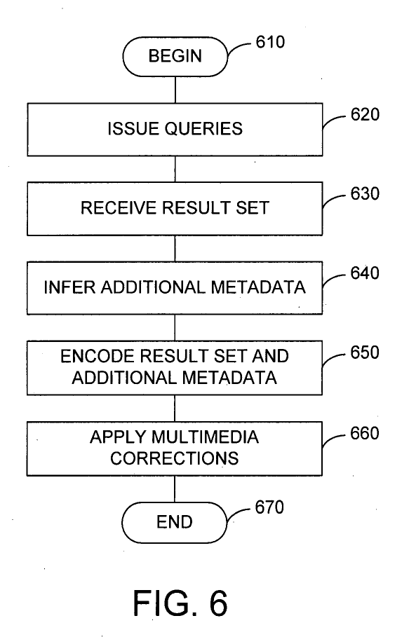

FIG. 6 is a flow diagram that illustrates a method to transfer multimedia data and metadata from the secure storage server to a communication device implementing the metadata system, according to embodiments of the invention.

The method begins in step 610 when the client is power on. In step 620 queries are issued to the secure storage server on a periodic interval. In step 630 multimedia data and metadata matching criteria included in queries are received in a result set. The multimedia data and metadata is stored and additional metadata is inferred in step 640. The multimedia data, metadata and additional metadata are encoded according to a specified format in step 650. In step 660 multimedia and metadata correction are applied based on the specified format. The method ends in step 660.

In summary, multimedia data and metadata is captured by multimedia captured devices and automatically transferred to a secure storage sever. The secure storage server utilizes tokens and username and password combinations to regulate access to the multimedia data and metadata. The multimedia data and metadata is downloaded from the secure storage server to an authenticated client and further processed based on standardized formats associated with the client.

An alternate embodiment may include a method of encoding voice metadata and multimedia data. A collection of schemas associated with formats of the multimedia data define the metadata for the multimedia data. A multimedia format may be associated with one or more schemas. The encoding merges the metadata and multimedia data based on the one or more schemas associated with the format of the multimedia data. When the metadata includes voice metadata, the voice metadata may be stored in a separate file and associated with the multimedia data and text metadata via a sidecar file. Additionally, the voice metadata may be converted to text metadata via a voice recognition function and encoded with multimedia data and text metadata. Thus, the metadata associated with the multimedia data may include a sidecar file storing the voice metadata and embedded text metadata that includes the converted voice metadata.

The foregoing descriptions of the invention are illustrative, and modifications in configuration and implementation will occur to persons skilled in the art. For instance, while the present invention has generally been described with relation to FIGS. 1-6, those descriptions are exemplary. Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims. The scope of the invention is accordingly intended to be limited only by the following claims.

We claim:

1. A computer-implemented method to transfer multimedia data between a first communication device and a second communication device, the method comprising:
capturing multimedia data and metadata on the first communication device;
associating the metadata with the multimedia data;
establishing a communication channel between the first communication device and the second communication device;
generating a communication message having the multimedia data and metadata; and
transmitting the communication message to the second communication device.

2. The method according to claim 1, wherein establishing a communication channel between the first communication device and the second communication device further comprises:
verifying that the second communication device is allowed to communicate with the second communication device; and
securing the communication channel to prevent unauthorized access.

3. The method according to claim 1, wherein the metadata and multimedia data are stored separately.

4. The method according to claim 1, wherein the first communication device is a digital camera, smartphone or a cameraphone.

5. The method according to claim 1, wherein the metadata includes a visibility attribute.

6. The method according to claim 1, wherein the metadata includes position information specifying a geographic location and orientation associated with the first communication device.

7. The method according to claim 1, wherein the metadata includes voice data.

8. The method according to claim 1, further comprising:
registering a third communication device at the second communication device;
notifying the third communication device when the second communication device receives new multimedia data and metadata; and
pushing the new multimedia data from the second communication device to the third communication device.

9. A computer-implemented method to transfer multimedia data captured on a first communication device to a second communication device, the method comprising:
authenticating the second communication device;
issuing queries specifying criteria for multimedia data;
receiving a result set having multimedia data that matches the criteria;
inferring additional metadata for the multimedia; and
encoding the additional metadata in a format associated with the multimedia data.

10. The method according to claim 9, wherein the multimedia data and metadata are stored separately.

11. The method according to claim 9, wherein the result set includes metadata associated with the multimedia data.

12. The method according to claim 11, further comprising:
encoding the received metadata in the format associated with the multimedia data.

13. The method according to claim 9, wherein the format associated with the multimedia data is IPTC, XMP or EXIF.

14. The method according to claim 9, wherein the additional metadata includes keywords or captions generated by manual annotations, face or voice recognition.

15. A system to transfer multimedia from a first communication device to a second communication device, the system comprising:
a first communication device to capture multimedia data and metadata;
a secure storage device to receive and store the multimedia data and metadata; and
a second communication device to issue queries and to encode the multimedia data and metadata.

16. The method according to claim 15, wherein the first communication device generates communication messages to transfer the captured multimedia data and metadata to the secure storage device.

17. The method according to claim 15, wherein the second communication device comprises:
a metadata handler to add metadata to the multimedia data; and
a policy engine to ensure the multimedia data and metadata are encoded in a specified format.

18. The method according to claim 15, wherein the first communication device authenticates at the secure storage device using a token.

19. The method according to claim 18, wherein the secure storage device is remote and external to the second communication device.

20. The method according to claim 18, wherein the secure storage device is part of the second communication device.
